(19) United States
(12) Patent Application Publication
(10) Pub. No.: US 2021/0300112 A1
(43) Pub. Date: Sep. 30, 2021

(54) UPRIGHT

(71) Applicant: JTEKT CORPORATION, Osaka (JP)

(72) Inventors: Motohiro FUJIYOSHI, Nagakute-shi (JP); Hideki SUGIURA, Nagakute-shi (JP); Hiroyuki YAMAGUCHI, Nagakute-shi (JP); Yoshikazu HATTORI, Nagakute-shi (JP); Yuya INOUE, Nagaokakyo-shi (JP); Yoichiro SANKAI, Kashiwara-shi (JP); Mahito SHIBA, Yamatotakada-shi (JP); Takuya HONJYOU, Nara-shi (JP)

(73) Assignee: JTEKT CORPORATION, Osaka (JP)

(21) Appl. No.: 17/211,226

(22) Filed: Mar. 24, 2021

(30) Foreign Application Priority Data
Mar. 30, 2020 (JP) 2020-060590

(51) Int. Cl. B60B 27/02; B62D 7/18; G01B 21/22

(52) U.S. Cl. CPC B60B 27/02; B62D 17/00; G01B 21/22; B62D 7/18

(57) ABSTRACT

An upright includes an axle hub, a hub carrier, and a hub tilt detector configured to detect a tilt of the axle hub with respect to the hub carrier. The hub carrier includes a hub support that supports the axle hub, a carrier body which holds the hub support and to which the sensor of the hub tilt detector is fixed, and a deformation member interposed between the hub support and the carrier body and made of a material having a lower Young's modulus than the carrier body.

### CROSS-REFERENCE TO RELATED APPLICATION

This application claims priority to Japanese Patent Application No. 2020-060590 filed on Mar. 30, 2020, incorporated herein by reference in its entirety.

### BACKGROUND

### 1. Technical Field

The disclosure relates to uprights to which wheels of a vehicle are attached.

### 2. Description of Related Art

Vehicles such as passenger cars and freight cars have uprights which are supported by a vehicle body via suspension arms, spring damper units, axles, etc. and to which wheels are attached. The upright includes a wheel hub and a hub carrier. The wheel is fixed to the wheel hub, and the wheel hub rotates with the wheel. The hub carrier is supported by the vehicle body via the suspension arms etc. and rotatably supports an axle hub. The upright herein includes a knuckle that supports a steered wheel.

Japanese Unexamined Patent Application Publication No. 2004-352046 (JP 2004-352046 A) discloses a method for obtaining a coefficient of friction (μ) of a road surface from an external force applied to a wheel. Japanese Unexamined Patent Application Publication No. 2006-292445 (JP 2006-292445 A) discloses a device for measuring displacement of an axle hub (hub 4) relative to a hub carrier (outer ring 3) to measure a force applied to the axle hub (hub 4) from the relative displacement. Japanese

Unexamined Patent Application Publication No. 2010-122067 (JP 2010-122067) also discloses a device for measuring displacement of an axle hub (hub shaft 13) relative to a hub carrier (outer ring 11) to measure an external force applied to the axle hub (hub shaft 13). The external force applied to the axle hub is associated with an external force applied to the wheel. The names and signs of the members in parentheses are the names and signs of the members used in the corresponding patent document and have nothing to do with the names and signs of members used in the description of the present application.

### SUMMARY

In order to obtain the external force applied to the wheel from the displacement of the axle hub, it is necessary that the displacement of the axle hub change with a change in external force, and it is ideally desired that the external force and the displacement have a linear relationship. However, the displacement includes components other than the component that changes according to a change in external force. In order to increase the detection accuracy of the displacement of the axle hub, it is desired that the component that changes according to a change in external force be large relative to the other components.

An upright for a vehicle according to a first aspect of the disclosure includes: an axle hub; a hub carrier that rotatably supports the axle hub; and a hub tilt detector configured to detect a tilt of the axle hub in a horizontal plane and a tilt of the axle hub in a vertical plane with respect to the hub carrier. The hub tilt detector includes a detection track provided on the axle hub, a sensor configured to acquire a distance to the detection track, and a tilt calculation unit configured to calculate a tilt of the hub carrier based on the distance between the sensor and the detection track. The hub carrier includes a hub support that supports the axle hub, a carrier body which holds the hub support and to which the sensor of the hub tilt detector is fixed, and a deformation member interposed between the hub support and the carrier body and made of a material having a lower Young's modulus than a Young's modulus of the carrier body.

Since the deformation member with a lower Young's modulus is interposed between the hub support and the carrier body, displacement of the hub support relative to the carrier body can be increased.

In the above aspect, the hub support may be a generally cylindrical member disposed coaxially with a rotation axis of the axle hub, and the carrier body may surround the hub support from outside in a radial direction with the deformation member interposed between the carrier body and the hub support.

In the above configuration, each of a surface of the hub support and a surface of the carrier body that face each other in the radial direction may have two tapered portions with a tapered shape tapered toward both ends in a direction along the rotation axis of the axle hub, and the deformation member may be disposed between the tapered portions that oppose each other. This configuration facilitates tilting of the axle hub.

In the above configuration, a middle portion of the hub support in the direction along the rotation axis of the axle hub may be in contact with the hub carrier, and the deformation member may be disposed on both sides of the middle portion. This configuration allows the axle hub to be tilted about the contact point.

In the above configuration, the deformation member may be configured as a plurality of deformation member segments spaced apart from each other in the direction along the rotation axis of the axle hub. This configuration allows the axle hub to be tilted to a greater extent when the same external force is applied, as compared to a configuration in which the deformation member is an integral, continuous deformation member segment.

In the above configuration, each of a surface of the hub support and a surface of the carrier body that face each other in the radial direction may have a cylindrical portion with a cylindrical shape in a middle in the direction along the rotation axis of the axle hub, and may have tapered portions with a tapered shape on both sides of the cylindrical portion, each of the tapered portions being tapered toward an end. The deformation member segments may be arranged between the cylindrical portions and between the tapered portions that oppose each other. This configuration facilitates tilting of the axle hub while reducing displacement of the axle hub in the radial direction.

In the above configuration, a density of arrangement of the deformation member segments may be higher in a middle portion than at ends in the direction along the rotation axis of the axle hub. The deformation member segment in the middle portion may be larger in width than the deformation member segments at the ends. An interval between the deformation member segments that are adjacent to each other in the middle portion may be smaller than an interval between the deformation member segments at the ends. This configuration facilitates tilting of the axle hub while reducing displacement of the axle hub in the radial direction.

In the above configuration, the deformation member segments arranged in front of and behind the axle hub in a longitudinal direction of the vehicle may be larger in number than the deformation member segments arranged above and below the axle hub in a vertical direction of the vehicle. This configuration makes sensitivity to tilting of the axle hub in a plane perpendicular to the longitudinal direction of the vehicle higher than sensitivity to tilting of the axle hub in the horizontal plane.

In the above configuration, the deformation member segments arranged in front of and behind the axle hub in the longitudinal direction of the vehicle may be larger in width than the deformation member segments arranged above and below the axle hub in the vertical direction of the vehicle. This configuration makes the sensitivity to tilting of the axle hub in a plane perpendicular to the longitudinal direction of the vehicle higher than the sensitivity to tilting of the axle hub in the horizontal plane.

In the above aspect, a stopper configured to contact the other of the hub support and the carrier body to limit a tilt angle of the axle hub may be provided on one of the hub support and the carrier body. This configuration prevents excessive tilting of the axle hub.

An upright for a vehicle according to a second aspect of the disclosure includes: an axle hub; a hub carrier that rotatably supports the axle hub; and a hub tilt detector configured to detect a tilt of the axle hub in a horizontal plane and a tilt of the axle hub in a vertical plane with respect to the hub carrier. The hub tilt detector includes a detection track provided on the axle hub, a sensor configured to acquire a distance to the detection track, and a tilt calculation unit configured to calculate a tilt of the hub carrier based on the distance between the sensor and the detection track. The hub carrier includes a hub support that supports the axle hub, a carrier body which holds the hub support and to which the sensor of the hub tilt detector is fixed, and a deformation member interposed between the hub support and the carrier body. The hub support is a generally cylindrical member disposed coaxially with a rotation axis of the axle hub. The carrier body surrounds the hub support from outside in a radial direction with the deformation member interposed between the carrier body and the hub support. The deformation member is configured as a plurality of deformation member segments spaced apart from each other in a direction along the rotation axis of the axle hub.

The above configuration increases displacement, particularly a tilt, of the hub support relative to the carrier body and improves detection accuracy of a load applied to a wheel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a wheel, a support structure for the wheel, and an external force applied to the wheel;

FIG. 2 illustrates a wheel 10 as viewed from the side;

FIG. 3 schematically illustrates a general configuration of an upright;

FIG. 4 illustrates an example of the configuration of a hub carrier;

FIG. 5 illustrates an example of the configuration of the hub carrier;

FIG. 6 illustrates an example of the configuration of the hub carrier;

FIG. 7 illustrates an example of the configuration of the hub carrier;

FIG. 8 illustrates an example of the configuration of the hub carrier;

FIG. 9 illustrates an example of the configuration of the hub carrier;

FIG. 10 illustrates an example of the configuration of the hub carrier;

FIG. 11 illustrates an example of the configuration of the hub carrier;

FIG. 12 illustrates an example of the configuration of the hub carrier;

FIG. 13 illustrates an example of the configuration of the hub carrier; and

FIG. 14 illustrates an example of the configuration of the hub carrier.

### DETAILED DESCRIPTION OF EMBODIMENTS

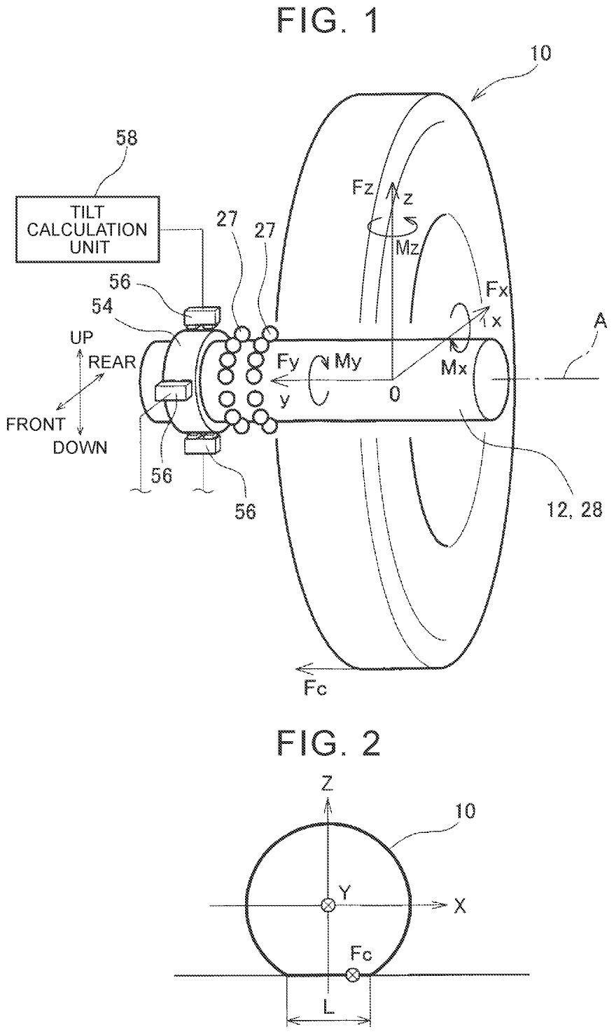

An embodiment of the disclosure will be described with reference to the accompanying drawings. FIG. 1 illustrates forces and moments that are applied to a wheel 10 of a vehicle. In FIG. 1, the origin 0 is a point located at the midpoint of the width of the wheel 10 on a rotation axis A of the wheel 10. The x-axis is an axis passing through the origin O, and the positive x-axis points toward the rear of the vehicle. The y-axis is an axis passing through the origin 0, and the positive y-axis points inward in the lateral direction of the vehicle. The z-axis is an axis passing through the origin O, and the positive z-axis points upward in the vertical direction of the vehicle. Fx, Fy, and Fz represent forces in the directions of the x-, y-, and z-axes, respectively. Mx, My, and Mz represent moments about the x-, y-, and z-axes, respectively. In the following description, the axial direction refers to a direction along the rotation axis A, and the radial direction refers to a direction perpendicular to the rotation axis A.

An external force that is applied to the wheel 10 during steady circular turning will be only a friction force Fc from the road surface in a direction along the y-axis (Fy=Fc) if friction in the traveling direction of the vehicle is ignored. The friction force Fc is given by the following equation:

Fc=mGy (1)

where m is the vehicle mass per wheel and Gy is the acceleration in the y-axis direction. Vertical drag N that is applied to the wheel 10 is given by the following equation:

N=mg (2)

where g is the gravitational acceleration. The friction force Fc is therefore given by the following equation:

Fc=μNT=μmg (3)

where μ is a coefficient of friction generated at that time. The following equation is obtained from the above equations (1) and (3):

μ=Gy/g (4).

The maximum value of the generated coefficient of friction μ is determined by characteristics of the road surface and tire, and this coefficient of friction is referred to as the road surface friction coefficient μa. (μ/μa) represents the ratio of the currently used coefficient of friction to the maximum available coefficient of friction, and this ratio is referred to as the friction coefficient utilization ratio. 1 minus the friction coefficient utilization rate represents a margin with respect to the maximum value of the friction force Fc, and this value is referred to as the grip margin ε. The grip margin ε is given by the following equation (5):

ε=1−(μ/μa) (5).

As shown in FIG. 2, the friction force Fc is applied to the wheel 10 at a position closer to the rear end of the contact range of the wheel 10 with the ground. This is because when the wheel 10 has a slip angle, rubber of the tread surface of the tire of the wheel 10 is deformed to a greater extent as it gets closer to the rear end of the contact range. As the friction force Fc is applied to the position offset to the rear end of the contact range, the moment Mz about the z-axis is applied.

According to JP 2004-352046 A described above, the moment Mz about the z-axis divided by the product of the force Fy in the y-axis direction and the ground contact length L (see FIG. 2) of the wheel 10 (Mf/FyL, hereinafter referred to as the “MF value”) is a function of the grip margin ε. Accordingly, by obtaining the grip margin ε from the MF value and obtaining the coefficient of friction μ generated at that time from the acceleration Gy based on the equation (4), the road surface friction coefficient μa can be obtained from the equation (5). In other words, the road surface friction coefficient μa can be obtained from the friction force Fc and the moment Mz about the z-axis.

Since the friction force Fc causes the moment about the x-axis, the friction force Fc can be obtained by detecting the tilt of an axle 12 in a yz plane. The moment Mz generated by the friction force Fc can be obtained by detecting the tilt of the axle 12 in an xy plane. An upright 14 of the present embodiment has a function to detect the tilt of the axle 12.

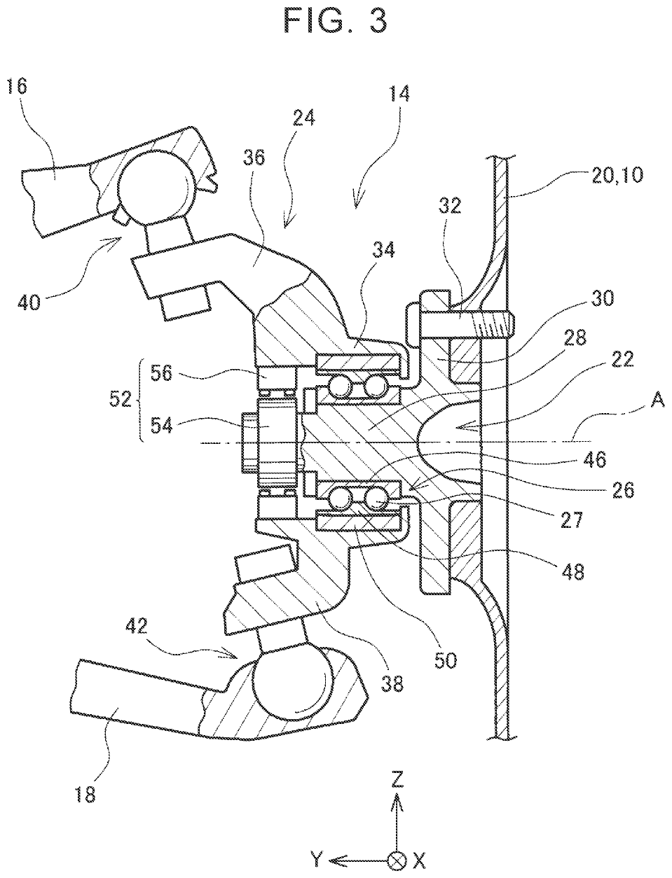

FIG. 3 schematically illustrates the configuration of the upright 14 and its surroundings. The x-, y-, and z-axes shown in FIG. 3 indicates only the directions, and the intersection of these axes does not indicate the origin of a coordinate system. The upright 14 is supported by a vehicle body via suspension parts such as suspension arms 16, 18. An example of the suspension parts other than the suspension arms is a spring damper unit that is a single element composed of a spring and a damper. The upright 14 rotatably supports the wheel 10.

The upright 14 includes an axle hub 22 and a hub carrier 24. The wheel 10, particularly a wheel disc 20 of the wheel 10, is connected to the axle hub 22, and the axle hub 22 rotates with the wheel 10. The hub carrier 24 is supported by the suspension arms 16, 18 and rotatably supports the axle hub 22. In order to rotatably support the axle hub 22, rolling elements 27 of a bearing 26 are interposed between the axle hub 22 and the hub carrier 24. The axle hub 22 includes a hub shaft 28 and a hub flange 30 that is integral with the hub shaft 28. A hub bolt 32 is inserted through the hub flange 30, and a hub nut (not shown) is screwed onto the hub bolt 32. The wheel disc 20 is thus connected to the hub flange 30. The axle hub 22 rotates with the wheel 10 about the centerline of the hub shaft 28. The centerline of the hub shaft 28 is therefore the rotation axis A of the wheel 10.

The hub carrier 24 includes a bearing holding portion 34, an upper upright arm 36, and a lower upright arm 38. The bearing holding portion 34 is disposed so as to surround the bearing 26 and supports the axle hub 22. The upper upright arm 36 extends upward from the bearing holding portion 34. The lower upright arm 38 extends downward from the bearing holding portion 34. Ball joints 40, 42 for connecting the upper upright arm 36 and the lower upright arm 38 to the suspension arms 16, 18 are located at an end of the upper upright arm 36 and an end of the lower upright arm 38, respectively.

The bearing 26 includes the rolling elements 27, an inner race 46, and an outer race 48. The inner race 46 and the outer race 48 are arranged so as to sandwich the rolling elements 27 therebetween. The rolling elements 27 of the bearing 26 are in the shape of a ball and are arranged in two rows. The inner race 46 is fixed to the axle hub 22 and rotates with the axle hub 22. The inner race 46 is integral with the axle hub 22, and in the following description, is regarded as a part of the axle hub 22. The bearing 26 may not have an independent inner race, and the axle hub 22, particularly the hub shaft 28 itself, may be configured to function as an inner race. The outer race 48 is fixed to the hub carrier 24 and is integral with the hub carrier 24. In the following description, the outer race 48 is regarded as a part of the hub carrier 24. The axle hub 22 including the inner race 46 is thus rotatably supported by the hub carrier 24 including the outer race 48 via the rolling elements 27.

The outer race 48 is a hub support supporting the axle hub 22 via the rolling elements 27 of the bearing 26, and the bearing holding portion 34 is a carrier body supporting the outer race 48 that is the hub support. A deformation member 50 is interposed between the outer race (hub support) 48 and the bearing holding portion (carrier body) 34. The deformation member 50 is made of a material having a lower Young's modulus than the bearing holding portion (carrier body) 34. In the case where the bearing holding portion 34 is made of rolled steel SS400 (Young's modulus: 206 GPa), the material of the deformation member 50 is, e.g., gray cast iron (100 GPa), 6-4 brass (103 GPa), phosphor bronze (110 GPa), aluminum alloy (about 70 GPa), rubber (elastomer) (0.001 GPa), etc. Due to the deformation member 50 with a low Young's modulus, the axle hub 22 will be deformed to a great extent with respect to the bearing holding portion 34 when an external force is applied.

The upright 14 includes a hub tilt detector 52 for detecting the tilt of the axle hub 22. The hub tilt detector 52 includes a detection track 54 and sensors 56. The detection track 54 is fixed to the hub shaft 28 and extends on the peripheral surface of the hub shaft 28 in the circumferential direction. The sensors 56 are fixed to the bearing holding portion 34 and are arranged so as to face the detection track 54. The sensors 56 are disposed at four positions, namely above, below, in front of, and behind the hub shaft 28, and each sensor 56 detects the distance to the detection track 54 at two positions in the direction of the rotation axis A. The distance is detected by, e.g., a method proposed in JP 2006-292445 A described above. In this proposed method, a detection track has ridges and recesses with a predetermined shape, and the distance is detected based on signals according to the ridges and recesses. The output of each sensor 56 is sent to a tilt calculation unit 58 (see FIG. 1). The tilt calculation unit 58 calculates the tilt of the hub shaft 28 in a plane (transverse plane) perpendicular to the longitudinal direction of the vehicle based on the outputs of the sensors 56 located above and below the hub shaft 28. The tilt calculation unit 58 also calculates the tilt of the hub shaft 28 in a horizontal plane based on the outputs of the sensors 56 located in front of and behind the hub shaft 28.

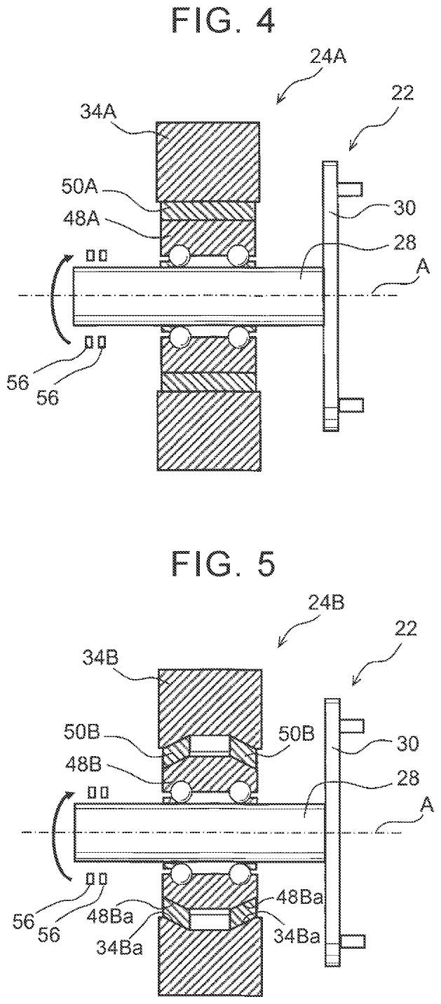

FIGS. 4 to 14 schematically illustrate examples of the configuration of the hub carrier 24. In the illustrated configuration examples, the same elements as those of the configuration in FIG. 3 are denoted by the same signs as those of FIG. 3, and the elements corresponding to those of the configuration of FIG. 3 are denoted by the same signs as those of FIG. 3 with the letters A to L at the end. FIGS. 4 to 14 particularly illustrate examples of the deformation member. In the illustrated examples, the outer race 48 and the bearing holding portion 34 vary in form depending on the form of the deformation member. Each of the illustrated deformation members is made of a material having a lower Young's modulus than the bearing holding portion.

FIG. 4 is a schematic view of a hub carrier 24A using a deformation member 50A that is an example of the configuration of the deformation member 50. The outer peripheral surface of an outer race 48A and the inner peripheral surface of a bearing holding portion 34A are cylindrical surfaces, and the interval between these two cylindrical surfaces is constant in the axial direction. The deformation member 50A is disposed in the space between the outer peripheral surface of the outer race 48A and the inner peripheral surface of the bearing holding portion 34A. The deformation member 50A may have a cylindrical shape or may be configured as a plurality of parts into which a cylindrical member is separated in the circumferential direction and which are arranged with clearance therebetween.

FIG. 5 is a schematic view of a hub carrier 24B using a deformation member 50B that is an example of the configuration of the deformation member 50. An outer race 48B is different from the outer race 48A (see FIG. 4) in the shape of the outer peripheral surface. The outer peripheral surface of the outer race 48B has tapered portions 48Ba at its both ends in the axial direction. Each tapered portion 48Ba is tapered toward the end in the axial direction. A bearing holding portion 34B is different from the bearing holding portion 34A in the shape of the inner peripheral surface. The inner peripheral surface of the bearing holding portion 34B has tapered portions 34Ba. The tapered portions 34Ba face the tapered portions 48Ba of the outer race 48B in the radial direction. The bore diameter of each tapered portion 34Ba becomes smaller toward the end in the axial direction. The deformation member 50B is disposed between the two opposing tapered portions 48Ba, 34Ba at each end. The deformation member 50B is also tapered toward the end in the axial direction. Due to the tapered shapes at both ends, the hub shaft 28 is held such that the hub shaft 28 is more likely to be tilted than to be translated in the radial direction.

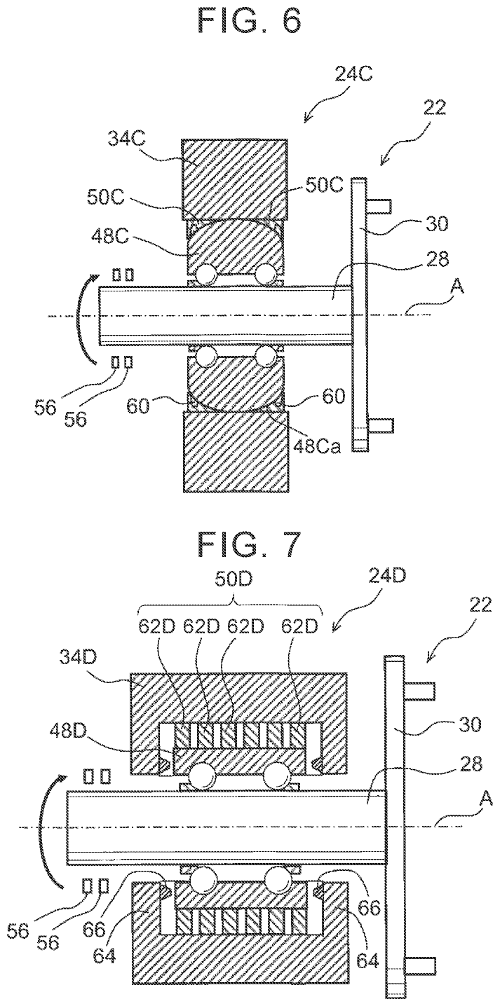

FIG. 6 is a schematic view of a hub carrier 24C using a deformation member 50C that is an example of the configuration of the deformation member 50. An outer race 48C is different from the outer race 48A (see FIG. 4) in the shape of the outer peripheral surface. An outer peripheral surface 48Ca of the outer race 48C is a convex surface curved outward in the radial direction. The outer peripheral surface 48Ca is in contact with the inner peripheral surface of a bearing holding portion 34C in the middle in the axial direction. The outer peripheral surface 48Ca of the outer race 48C shown in FIG. 6 has a convex shape curved outward, particularly an arc shape, in section. Alternatively, the outer peripheral surface 48Ca may have a mountain shape in section that is composed of two straight lines. The deformation member 50C is disposed on both sides of the middle portion in the axial direction, namely on both sides of the contact portion between the outer race 48C and the bearing holding portion 34C in the axial direction. Since the outer race 48C and the bearing holding portion 34C are in contact with each other in the middle in the axial direction, translation of the hub shaft 28 in the radial direction is restrained. Since the structure that allows deformation is provided on both sides of the middle portion in the axial direction, tilting of the hub shaft 28 is allowed. A stopper 60 is provided at each edge of the outer peripheral surface 48Ca of the outer race 48C in the axial direction. Each stopper 60 has an annular shape about the rotation axis A and is disposed with predetermined clearance between the outer peripheral surface of the stopper 60 and the inner peripheral surface of the bearing holding portion 34C. The stoppers 60 may be made of a material having a higher Young's modulus than the deformation member 50C and are preferably made of the same material as the outer race 48C or the bearing holding portion 34C. When the hub shaft 28 is tilted to some extent, the stoppers 60 come into contact with the bearing holding portion 34 and limit further tilting of the hub shaft 28. The tilt of the hub shaft 28 when the slip angle of the wheel 10 is small need only be detected in order to calculate the generated coefficient of friction μ, and the stoppers 60 limit tilting of the hub shaft 28 so as not to impair the steering stability of the vehicle. The stoppers 60 may be provided on the bearing holding portion 34C instead of on the outer race 48C. The stopper may be applied to the hub carrier shown in FIGS. 4 and 5.

FIG. 7 is a schematic view of a hub carrier 24D using a deformation member 50D that is an example of the configuration of the deformation member 50. The outer peripheral surface of an outer race 48D and the inner peripheral surface of a bearing holding portion 34D are cylindrical surfaces, and the deformation member 50D is disposed in the space between the two cylindrical surfaces. The deformation member 50D is configured as a plurality of deformation member segments 62D spaced apart from each other in the axial direction. Rigidity is reduced by configuring the deformation member 50D as the deformation member segments 62D. Each deformation member segment 62 has an annular shape about the rotation axis A. Each deformation member segment 62 may be configured as a plurality of parts separated in the circumferential direction.

The bearing holding portion 34D has flanges 64 at both ends in the axial direction. The flanges 64 extend inward in the radial direction. A stopper 66 is provided on a part of each flange 64 that faces the outer race 48D. The stoppers 66 may be made of a material having a higher Young's modulus than the deformation member 50D and are preferably made of the same material as the outer race 48D or the bearing holding portion 34D. When the hub shaft 28 is tilted to some extent, the outer race 48D comes into contact with the stoppers 66 and limits further tilting of the hub shaft 28. The stoppers 66 may be provided on the outer race 48D instead of on the bearing holding portion 34D.

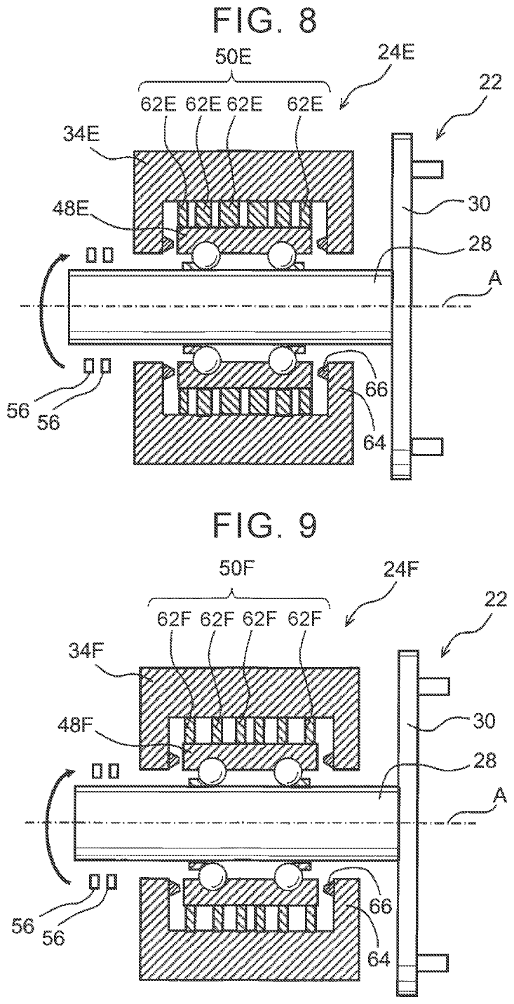

FIG. 8 is a schematic view of a hub carrier 24E using a deformation member 50E that is an example of the configuration of the deformation member 50. A hub carrier 24E is different from the hub carrier 24D (see FIG. 7) only in the form of the deformation member. Like the deformation member 50D, the deformation member 50E is composed of a plurality of deformation member segments 62E spaced apart from each other in the axial direction. The deformation member segments 62E are configured so that the density of the arrangement of the deformation member segments 62E is high in the middle portion in the axial direction and low at the ends in the axial direction. Specifically, the deformation member segments 62E in the middle portion in the axial direction have a large width (axial dimension) and the deformation member segments 62E at the ends in the axial direction have a small width (axial dimension). The intervals between the adjacent deformation member segments 62E are the same. The width of each deformation member segment 62E may be designed so as to decrease either gradually or stepwise from the middle portion in the axial direction toward the ends in the axial direction.

FIG. 9 is a schematic view of a hub carrier 24F using a deformation member 50F that is an example of the configuration of the deformation member 50. The hub carrier 24F is different from the hub carrier 24D (see FIG. 7) only in the form of the deformation member. Like the deformation member 50D, the deformation member 50F is composed of a plurality of deformation member segments 62F spaced apart from each other in the axial direction. The deformation member segments 62F are configured so that the density of the arrangement of the deformation member segments 62F is high in the middle portion in the axial direction and low at the ends in the axial direction. Specifically, the interval between the adjacent deformation member segments 62F is small in the middle portion in the axial direction and large at the ends in the axial direction. Each deformation member segment 62F has the same width (axial dimension). The interval between the adjacent deformation member segments 62F may be designed so as to increase either gradually or stepwise from the middle portion in the axial direction toward the ends in the axial direction.

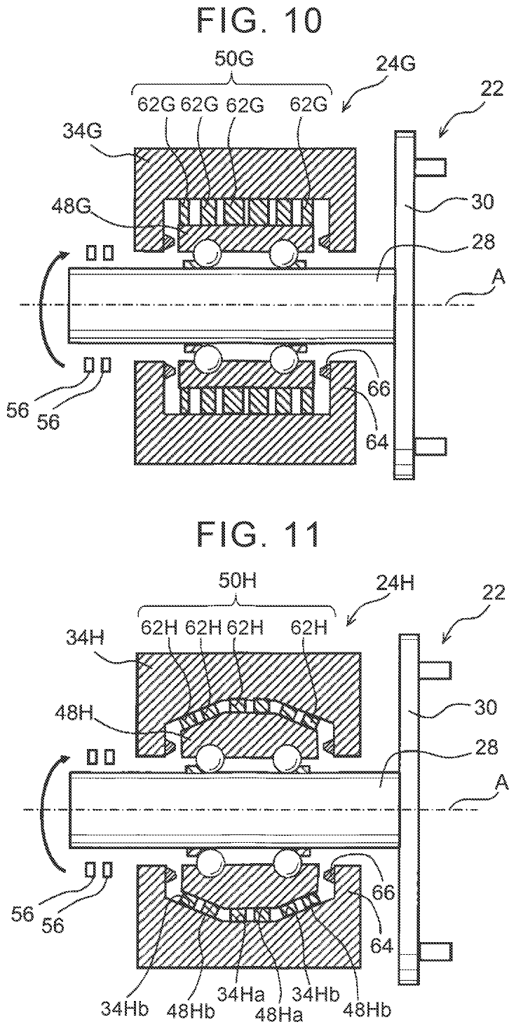

FIG. 10 is a schematic view of a hub carrier 24G using a deformation member 50G that is an example of the configuration of the deformation member 50. The hub carrier 24G is different from the hub carrier 24D (see FIG. 7) only in the form of the deformation member. Like the deformation member 50D, the deformation member 50G is composed of a plurality of deformation member segments 62G spaced apart from each other in the axial direction. The deformation member segments 62G are configured so that the density of the arrangement of the deformation member segments 62G is high in the middle portion in the axial direction and low at the ends in the axial direction. Specifically, the deformation member segments 62G in the middle portion in the axial direction have a large width (axial dimension) and the deformation member segments 62G at the ends in the axial direction have a small width (axial dimension). Moreover, the interval between the adjacent deformation member segments 62G is small in the middle portion in the axial direction and large at the ends in the axial direction. The width of each deformation member segment 62G may be designed so as to decrease either gradually or stepwise from the middle portion in the axial direction toward the ends in the axial direction. The interval between the adjacent deformation member segments 62G may be designed so as to increase either gradually or stepwise from the middle portion in the axial direction toward the ends in the axial direction.

The deformation members 50E, 50F, and 50G shown in FIGS. 8 to 10 are more likely to be deformed at the ends than in the middle portion in the axial direction. The hub shaft 28 is thus held such that the hub shaft 28 is more likely to be tilted than to be translated in the radial direction.

FIG. 11 is a schematic view of a hub carrier 24H using a deformation member 50H that is an example of the configuration of the deformation member 50. An outer race 48H is different from the outer race 48D shown in FIG. 7 in the shape of the outer peripheral surface. The outer peripheral surface of the outer race 48H has a cylindrical portion 48Ha in the middle in the axial direction and tapered portions 48Hb at both ends in the axial direction. Each tapered portions 48Hb is tapered toward the end in the axial direction. A bearing holding portion 34H is different from the bearing holding portion 34D shown in FIG. 7 in the shape of the inner peripheral surface. The inner peripheral surface of the bearing holding portion 34H has a cylindrical portion 34Ha and tapered portions 34Hb. The cylindrical portion 34Ha and the tapered portions 34Hb face the cylindrical portion 48Ha and the tapered portions 48Hb of the outer race 48H in the radial direction, respectively. The bore diameter of each tapered portion 34Hb becomes smaller toward the end in the axial direction. The deformation member 50H is composed of a plurality of deformation member segments 62H spaced apart from each other in the axial direction. A predetermined number of deformation member segments 62H are disposed between the cylindrical portion 48Ha of the outer race 48H and the cylindrical portion 34Ha of the bearing holding portion 34H and between each tapered portion 48Hb of the outer race 48H and each tapered portion 34Hb of the bearing holding portion 34H. Due to the tapered shapes at both ends, the hub shaft 28 is held such that the hub shaft 28 is more likely to be tilted than to be translated in the radial direction.

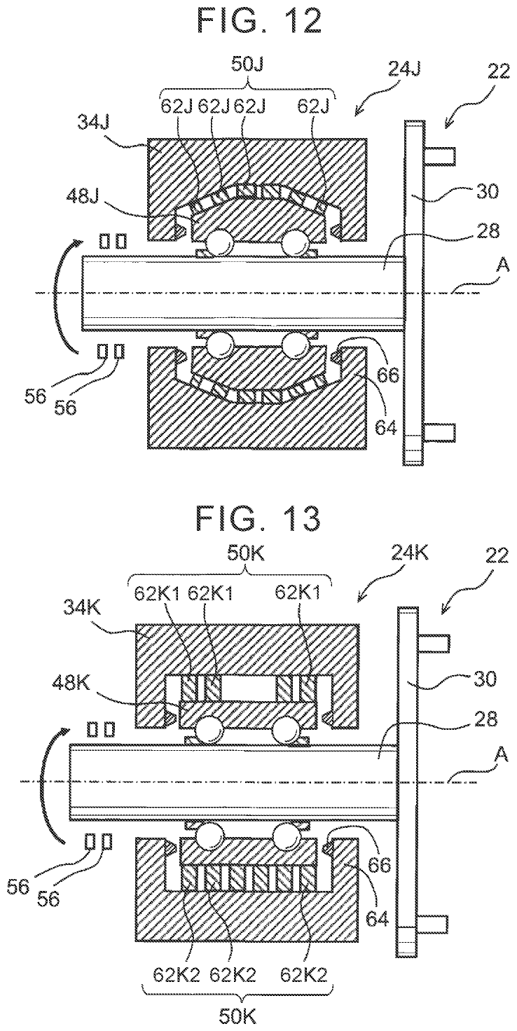

FIG. 12 is a schematic view of a hub carrier 24J using a deformation member 50J that is an example of the configuration of the deformation member 50. The hub carrier 24J is different from the hub carrier 24H (see FIG. 11) only in the form of the deformation member. Like the deformation member 50H, the deformation member 50J is composed of a plurality of deformation member segments 62J separated from each other in the axial direction. The deformation member segments 62J are configured so that the density of the arrangement of the deformation member segments 62J is high in the middle portion in the axial direction and low at the ends in the axial direction. Specifically, the deformation member segments 62J in the middle portion in the axial direction have a large width (axial dimension) and the deformation member segments 62J at the ends in the axial direction have a small width (axial dimension). Moreover, the interval between the adjacent deformation member segments 62J is small in the middle portion in the axial direction and large at the ends in the axial direction. The width of each deformation member segment 62J may be designed so as to decrease either gradually or stepwise from the middle portion in the axial direction toward the ends in the axial direction. The interval between the adjacent deformation member segments 62J may be designed so as to increase either gradually or stepwise from the middle portion in the axial direction toward the ends in the axial direction. The deformation member 50J is more likely to be deformed at the ends in the axial direction. The hub shaft 28 is thus held such that the hub shaft 28 is more likely to be tilted than to be translated in the radial direction.

FIG. 13 is a schematic view of a hub carrier 24K using a deformation member 50K that is an example of the configuration of the deformation member 50. In FIG. 13, a portion above the centerline (rotation axis A) shows a vertical section, and a portion below the centerline (rotation axis A) shows a horizontal section. The hub carrier 24K is different from the hub carrier 24D (see FIG. 7) only in the form of the deformation member. The deformation member 50K is composed of a plurality of deformation member segments 62K1, 62K2 spaced apart each other in the axial direction. The configuration of the deformation member segments 62K1, 62K2 of the deformation member 50K varies between the vertical direction and the longitudinal direction. The density of the arrangement of the deformation member segments 62K1 arranged in the axial direction above and below the hub shaft 28 is lower than the density of the arrangement of the deformation member segments 62K2 arranged in the axial direction in front of and behind the hub shaft 28. Specifically, the deformation member segments 62K1, 62K2 have the same shape, but the number of deformation member segments 62K1 arranged above and below the hub shaft 28 is smaller than the number of deformation member segments 62K2 arranged in front of and behind the hub shaft 28. Since the density of the arrangement of the deformation member segments 62K1 is different from the density of the arrangement of the deformation member segments 62K2, the rigidity of the deformation member 50K varies between its vertical and horizontal sections. The sensitivity to the moment about the x-axis is thus made higher than the sensitivity to the moment about the y-axis.

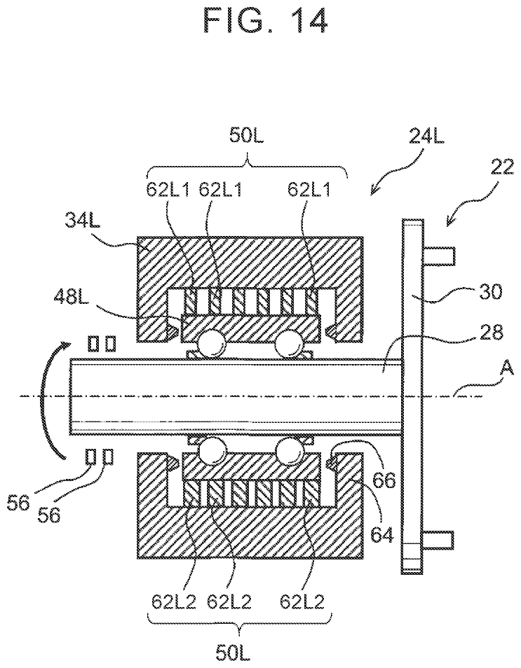

FIG. 14 is a schematic view of a hub carrier 24L using a deformation member 50L that is an example of the configuration of the deformation member 50. In FIG. 14, a portion above the centerline (rotation axis A) shows a vertical section, and a portion below the centerline (rotation axis A) shows a horizontal section. The hub carrier 24L is different from the hub carrier 24D (see FIG. 7) only in the form of the deformation member. The deformation member 50L is composed of a plurality of deformation member segments 62L1, 62L2 spaced apart each other in the axial direction. The configuration of the deformation member segments 62L1, 62L2 of the deformation member 50L varies between the vertical direction and the longitudinal direction. The density of the arrangement of the deformation member segments 62L1 arranged in the axial direction above and below the hub shaft 28 is lower than the density of the arrangement of the deformation member segments 62L2 arranged in the axial direction in front of and behind the hub shaft 28. Specifically, the number of deformation member segments 62L1 and the number of deformation member segments 62L2 are the same, but the width (dimension in the direction of the rotation axis A) of the deformation member segments 62L1 arranged above and below the hub shaft 28 is smaller than that of the deformation member segments 62L2 arranged in front of and behind the hub shaft 28. Since the deformation member segments 62L1, 62L2 have different widths, the rigidity of the deformation member 50L varies between its vertical and horizontal sections. The sensitivity to the moment about the x-axis is thus made higher than the sensitivity to the moment about the y-axis.

In the hub carrier 24K and the hub carrier 24L, the rigidity is varied by making the deformation member segments arranged above and below the hub shaft 28 different in either number or width from the deformation member segments arranged in front of or behind the hub shaft 28. However, the deformation member segments arranged above and below the hub shaft 28 may be different in both number and width from the deformation member segments arranged in front of or behind the hub shaft 28.

In an embodiment in which the deformation member is configured as a plurality of deformation member segments spaced apart from each other in a direction along the rotation axis, the deformation member can be made of the same material as the bearing holding portion. Since the deformation member is configured as the deformation member segments, the rigidity is reduced, and tilting of the axle hub in response to an external force on the wheel is increased.

What is claimed is:

1. An upright for a vehicle, comprising:
an axle hub;
a hub carrier that rotatably supports the axle hub; and
a hub tilt detector configured to detect a tilt of the axle hub in a horizontal plane and a tilt of the axle hub in a vertical plane with respect to the hub carrier, wherein
the hub tilt detector includes a detection track provided on the axle hub, a sensor configured to acquire a distance to the detection track, and a tilt calculation unit configured to calculate a tilt of the hub carrier based on the distance between the sensor and the detection track, and
the hub carrier includes a hub support that supports the axle hub, a carrier body which holds the hub support and to which the sensor of the hub tilt detector is fixed, and a deformation member interposed between the hub support and the carrier body and made of a material having a lower Young's modulus than a Young's modulus of the carrier body.

2. The upright according to claim 1, wherein:
the hub support is a generally cylindrical member disposed coaxially with a rotation axis of the axle hub; and
the carrier body surrounds the hub support from outside in a radial direction with the deformation member interposed between the carrier body and the hub support.

3. The upright according to claim 2, wherein:
each of a surface of the hub support and a surface of the carrier body that face each other in the radial direction has two tapered portions with a tapered shape tapered toward both ends in a direction along the rotation axis of the axle hub; and
the deformation member is disposed between the tapered portions that oppose each other.

4. The upright according to claim 2, wherein:
a middle portion of the hub support in a direction along the rotation axis of the axle hub is in contact with the hub carrier; and
the deformation member is disposed on both sides of the middle portion.

5. The upright according to claim 2, wherein the deformation member is configured as a plurality of deformation member segments spaced apart from each other in a direction along the rotation axis of the axle hub.

6. The upright according to claim 5, wherein:
each of a surface of the hub support and a surface of the carrier body that face each other in the radial direction has a cylindrical portion with a cylindrical shape in a middle in the direction along the rotation axis of the axle hub, and has tapered portions with a tapered shape on both sides of the cylindrical portion, each of the tapered portions being tapered toward an end; and
the deformation member segments are arranged between the cylindrical portions and between the tapered portions that oppose each other.

7. The upright according to claim 5, wherein a density of arrangement of the deformation member segments is higher in a middle portion than at ends in the direction along the rotation axis of the axle hub.

8. The upright according to claim 7, wherein the deformation member segment in the middle portion is larger in width than the deformation member segments at the ends.

9. The upright according to claim 7, wherein an interval between the deformation member segments that are adjacent to each other in the middle portion is smaller than an interval between the deformation member segments at the ends.

10. The upright according to claim 5, wherein the deformation member segments arranged in front of and behind the axle hub in a longitudinal direction of the vehicle are larger in number than the deformation member segments arranged above and below the axle hub in a vertical direction of the vehicle.

11. The upright according to claim 5, wherein the deformation member segments arranged in front of and behind the axle hub in a longitudinal direction of the vehicle are larger in width than the deformation member segments arranged above and below the axle hub in a vertical direction of the vehicle.

12. The upright according to claim 1, wherein a stopper configured to contact the other of the hub support and the carrier body to limit a tilt angle of the axle hub is provided on one of the hub support and the carrier body.

13. An upright for a vehicle, comprising:
an axle hub;
a hub carrier that rotatably supports the axle hub; and
a hub tilt detector configured to detect a tilt of the axle hub in a horizontal plane and a tilt of the axle hub in a vertical plane with respect to the hub carrier, wherein
the hub tilt detector includes a detection track provided on the axle hub, a sensor configured to acquire a distance to the detection track, and a tilt calculation unit configured to calculate a tilt of the hub carrier based on the distance between the sensor and the detection track,
the hub carrier includes a hub support that supports the axle hub, a carrier body which holds the hub support and to which the sensor of the hub tilt detector is fixed, and a deformation member interposed between the hub support and the carrier body,
the hub support is a generally cylindrical member disposed coaxially with a rotation axis of the axle hub,
the carrier body surrounds the hub support from outside in a radial direction with the deformation member interposed between the carrier body and the hub support, and
the deformation member is configured as a plurality of deformation member segments spaced apart from each other in a direction along the rotation axis of the axle hub.

14. The upright according to claim 13, wherein:
each of a surface of the hub support and a surface of the carrier body that face each other in the radial direction has a cylindrical portion with a cylindrical shape in a middle in the direction along the rotation axis of the axle hub, and has tapered portions with a tapered shape on both sides of the cylindrical portion, each of the tapered portions being tapered toward an end; and
the deformation member segments are arranged between the cylindrical portions and between the tapered portions that oppose each other.

15. The upright according to claim 13, wherein a density of arrangement of the deformation member segments is higher in a middle portion than at ends in the direction along the rotation axis of the axle hub.

16. The upright according to claim 15, wherein the deformation member segment in the middle portion is larger in width than the deformation member segments at the ends.

17. The upright according to claim 15, wherein an interval between the deformation member segments that are adjacent to each other in the middle portion is smaller than an interval between the deformation member segments at the ends.

18. The upright according to claim 13, wherein the deformation member segments arranged in front of and behind the axle hub in a longitudinal direction of the vehicle are larger in number than the deformation member segments arranged above and below the axle hub in a vertical direction of the vehicle.

19. The upright according to claim 13, wherein the deformation member segments arranged in front of and behind the axle hub in a longitudinal direction of the vehicle are larger in width than the deformation member segments arranged above and below the axle hub in a vertical direction of the vehicle.

20. The upright according to claim 13, wherein a stopper configured to contact the other of the hub support and the carrier body to limit a tilt angle of the axle hub is provided on one of the hub support and the carrier body.
